(19) United States
(12) Patent Application Publication
(10) Pub. No.: US 2019/0186668 A1
(43) Pub. Date: Jun. 20, 2019

(54) TEE CONNECTOR

(71) Applicant: Altura Manufacturing, LLC, Odessa, TX (US)

(72) Inventor: Lindsey Lee, Houston, TX (US)

(21) Appl. No.: 15/846,980

(22) Filed: Dec. 19, 2017

(51) Int. Cl. F16L 41/02

(52) U.S. Cl. CPC F16L 41/021

(57) ABSTRACT

A connecting tee is provided. The connecting tee comprises a run defining first and second openings at first and second ends thereof; a rise defining a rise opening and an inner surface defining a flow path through the rise and run, the flow path being interrupted by at least one raised portion on the inner surface.

### BACKGROUND

The current disclosure is directed to a connecting tee, or tee connector with grooved ends for connecting to other components. Connecting tees are commonly used in a number of industries for splitting and/or combining fluid flow. A connecting tee can comprise a reducing tee, in which one of the three end connections of the tee is of a different size than the two other ends, or the three end connections of the connecting tee can be the same size such that all of the flow connections have the same size openings. Connecting tees are utilized commercially for a number of different applications, including but not limited to oil and gas, plumbing and other industrial applications. As a result, connecting tees are exposed to a number of different pressures and must be designed to withstand certain high pressures to prevent failures.

### BRIEF DESCRIPTION OF THE DRAWINGS

FIG. 1 is a perspective view of the connecting tee of the current disclosure.

FIG. 2 is a side view of the connecting tee of the current disclosure.

FIG. 3 is a cross section view of the connecting tee of the current disclosure.

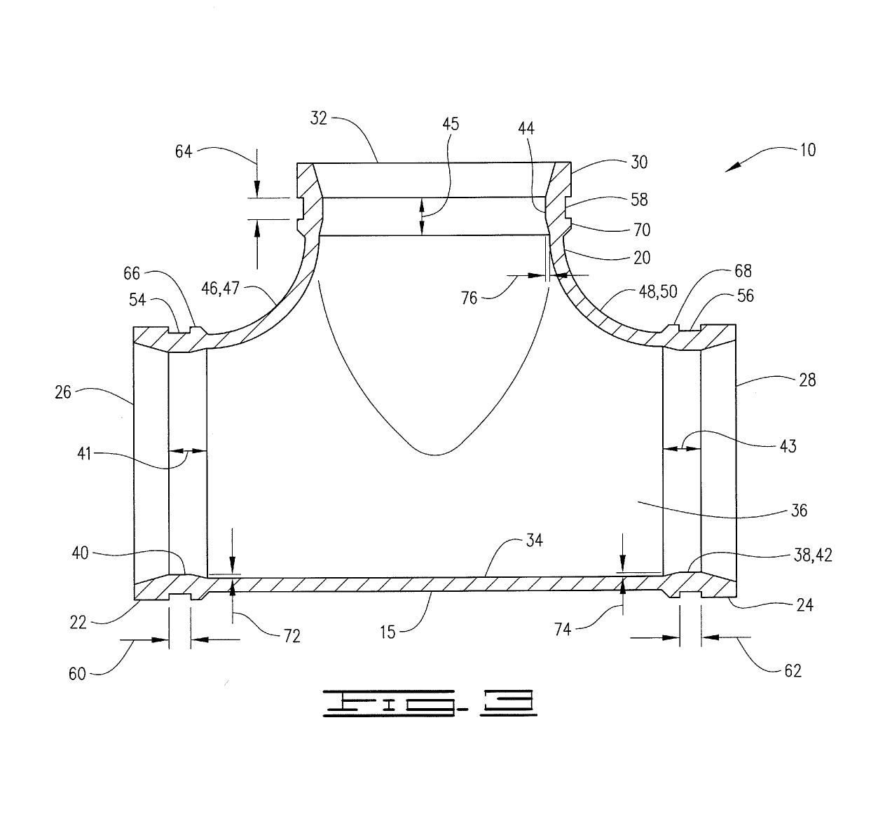

FIG. 4 is a view of a prior art connecting tee.

### SUMMARY

The current disclosure in one embodiment provides a connecting tee. The connecting tee has a rise and a run and an inner surface defining a flow path therethrough. The connecting tee has at least one raised portion on the inner surface thereof that extends radially inwardly into the flow path. In one embodiment the at least one raised portion may comprise three bumps or raised portions on the inner surface of the connecting tee that extend radially inwardly into the flow path of fluid flowing in the connecting tee.

An embodiment of the current disclosure may also include a plurality of grooves. The plurality of grooves may include first and second grooves in an outer surface defined on the run of the connecting tee and a third groove defined in the outer surface on the rise of the connecting tee. The first, second and third raised portions are located proximate first, second and third grooves such that the raised portions are aligned with the grooves. The raised portions on the inner surface are thus next to, or adjacent a groove on the outer surface of the tee connector. First, second and third raised portions have first, second and third lengths which span the first, second and third groove lengths of first, second and third grooves respectively.

In an additional embodiment, a connecting tee has a rise and a run. An inner surface of the connecting tee defines a flow path therethrough. An outer surface defines a periphery at a transition between the rise and run. The transition between the rise and the run is arcuate in a longitudinal direction and in a vertical direction such that there are no flat portions around the entire periphery of the transition between the rise and the run. The outer surface has a plurality of grooves and in one embodiment has three grooves thereon configured to connect the connecting tee to a pipe component at the ends of the rise and run. In one embodiment the connecting tee has first and second grooves on the run and a third groove on the rise, each configured to connect to a pipe component. Openings at the first and second ends of the run and at the end of the rise may in one embodiment be configured to have the same size openings thereon and configured to connect to pipe components of the same size.

The connecting tee of the current disclosure is an advance over prior art tees in that it will achieve a higher burst or failure pressure than a prior art tee that utilizes the same material and has the same or very nearly the same dimensions.

### DESCRIPTION OF AN EMBODIMENT

A connecting tee 10 has a run 15 and a rise 20. Rise 20 is connected to run 15. Run 15 has first end 22 and second end 24. A first opening 26 is defined at first end 22 and a second opening 28 is defined at second end 24. An end 30 of rise 20, which may be referred to as the rise end 30 defines a third opening 32. Connecting tee 10 is configured at each of the first, second and third ends 22, 24 and 30 to be connected to a pipe component. For example, each end may be connected to a straight piece of pipe, a coupling, elbow or any other fitting used to communicate fluid flow thereto.

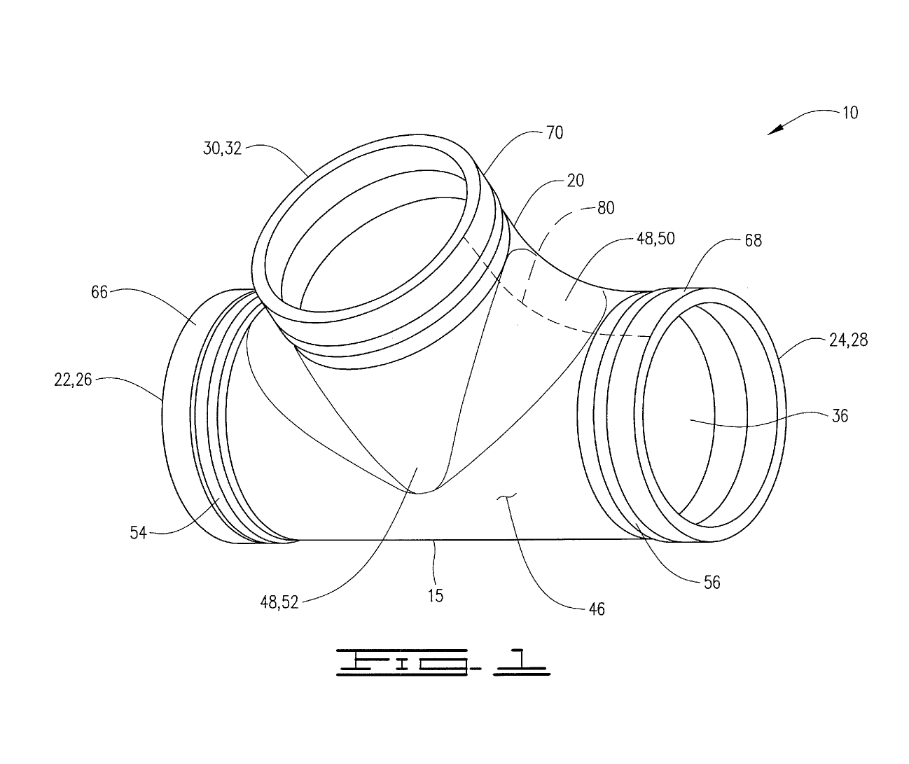

An inner surface 34 defines a flow path 36 through the tee 10. Flow path 34 extends longitudinally through run 15 and vertically through the rise 20 as shown in FIG. 1. Connecting tee 10 may be utilized to combine flow paths or to divide flow paths depending upon the application and use thereof. The connecting tee 10 of the current disclosure may be utilized in any number commercial industries including but limited to oil and gas, power petrochemichal, firewater and other industrial applications. Inner surface 34 is a generally smooth surface that has a plurality of raised portions or bumps 38 thereon that interrupt the smooth inner surface 34. Raised portions 38 extend radially inwardly into flow path 36. Raised portions 38 may include first and second raised portions 40 and 42 on inner surface 34 in run 15, and a third raised portion 44 on inner surface 34 in rise 20. First, second and third raised portions 40, 42 and 44 have lengths 41, 43 and 45 respectively, and are positioned at, or near ends 22, 24 and 30 respectively.

An outer surface 46 defines a periphery 47 of connecting tee 10. Connecting tee 10 includes a transition 48 between the rise 15 and run 20. Transition 48 is arcuate around the entire periphery thereof. In other words, there are no flat portions thereon. Transition 48 includes a longitudinal transition 50, which is the transition in a longitudinal direction between the rise 15 and the run 20. Transition 48 likewise includes a transition portion 52, which is the vertical transition in the direction between the rise and the run. There is no flat spot at transition portions 50 or 52 or anywhere on the periphery 47 of transition 48. As explained in detail below, prior art connecting tees with the same size ends on the rise and run have flat spots in the transition that affect the strength and integrity of the tees.

Outer surface 46 includes a plurality of grooves which may comprise first, second and third grooves 54, 56 and 58. First and second grooves 54 and 56 are positioned on run 15 at or near first and second ends 22 and 24 and third groove 58 is positioned on rise 20 at or near rise end 30. First groove 54 has length 60, second groove 56 has length 62 and third groove 58 has length 64.

Grooves 54, 56 and 58 defined in outer surface 46 are defined in radially outwardly extending portions of the outer surface which may be referred to first, second and third shoulders 66, 68 and 70. Grooves 54, 56 and 58 are positioned at first, second and third ends 22, 24 and 30 respectively.

Each of raised portions 40, 42 and 44 extend radially inwardly to a maximum height which may be, for example, heights 72, 74 and 76 respectively. As non-limiting example, the raised parts may have a height that is for example, about 0.03 to about 0.10 inches. Raised portions 42, 44 and 46 are positioned adjacent grooves 54, 56 and 58 respectively and thus are aligned therewith. Raised portions 42, 44 and 46 span the length of the corresponding groove with which it is aligned such that the overall length 41 of raised portion 40 spans length 60 of first groove 54. Length 43 of second raised portion 38 is such that it will span length 62 of second groove 56. Finally, length 45 of third raised portion 44 will span the length 64 of third groove 58. The length of the raised portions may be, for example three to four times the length of the corresponding groove, but in any case will at least span the length of the corresponding groove. The raised portions associated with the grooves are intended to lower material stresses in the groove area—thus increasing the pressure to fail over connecting tees without this feature. The raised portions structurally reinforce the groove area to better and more safely resist external loads on the tee assembly and reduce the likelihood that external forces applied to the tee assembly might damage the tee structurally. Since the connecting tee 10 would include three separate “connections”, the structural enhancement herein described would create a safer product less likely to fail due to the combined stresses imparted due to alignment issues and loads applied to all three connections.

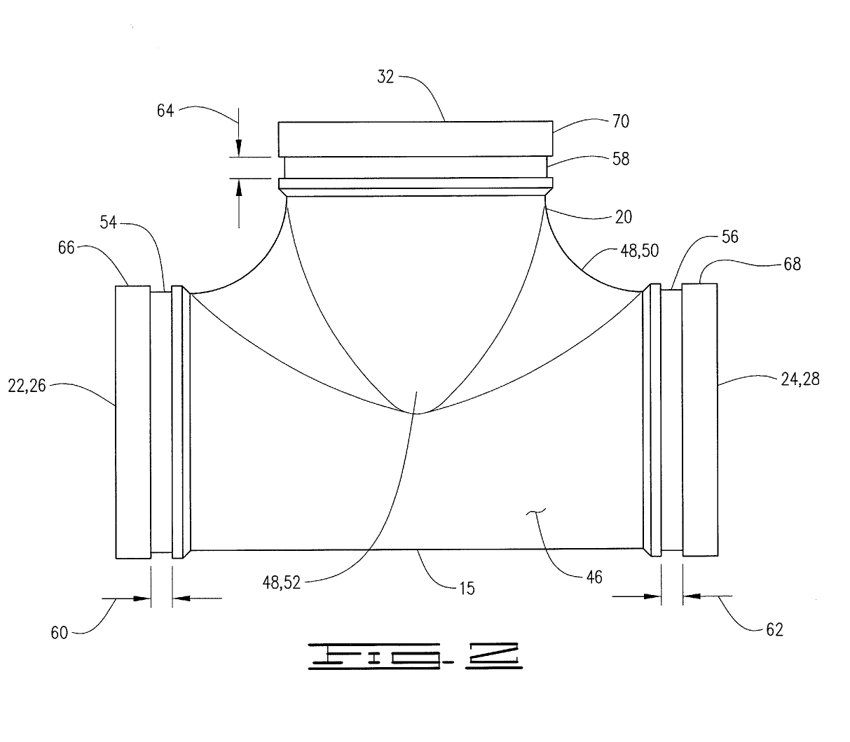

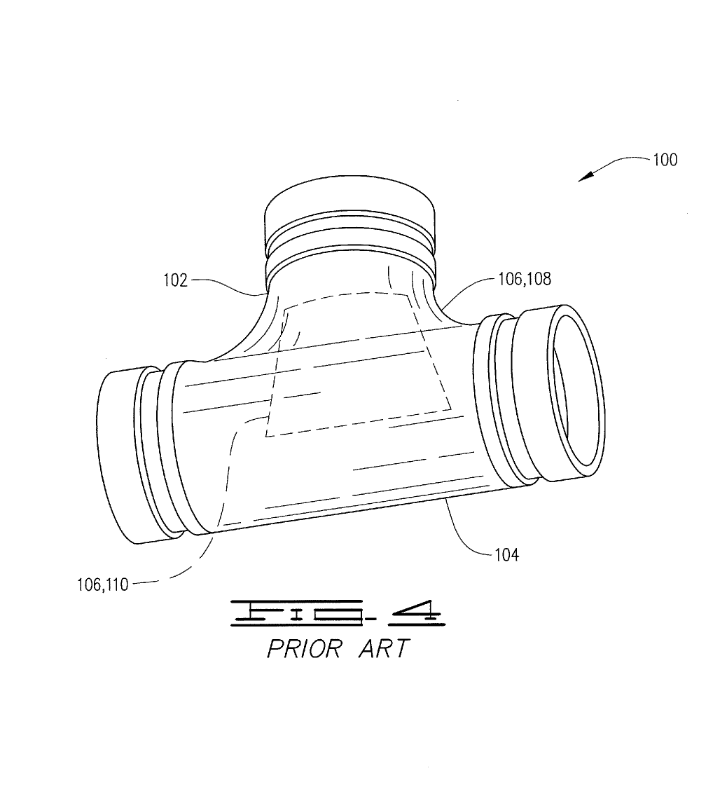

The combination of features set forth herein provides for more efficient use of material and provides additional strength over prior art connecting tees. Connecting tee 10 will thus have a higher burst pressure than prior art. For example, a prior art casting made of ASTM A536 Grade 65 45 12 Ductile Iron with a 4 inch diameter at each of the first, second and third ends, might have a burst pressure of a approximately 3200 psi. In contrast, a connecting tee 10 of the current disclosure made from the same material can have as high as a burst pressure of 3900 psi. The connecting tee 10 of the current disclosure essentially moves the failure point of current prior art tees and as a result adds additional strength. For example, as shown in FIG. 4, a prior art tee 100 has a rise 102 and a run 104 and includes a transition 106. Transition 106 comprises a transition 108 along the longitudinal direction and a transition 110 in the vertical direction from the rise 102 to the run 104. As is apparent, the prior art tee 100 has a flat portion 112 which often is a generally triangular flat portion as depicted by the dashed lines 114 in the figure. The tees in the prior art have a tendency to fail at or around the dashed line in FIG. 4, which essentially circumscribes the flat portion in the prior art tee 100. The tee 10 of the current disclosure will generally fall along what is typically known as the casting split line. That line is depicted by the dashed line 80 in FIG. 2. As a result, the burst pressure is much higher than with current designs. The engineering principal behind all of this has to do with how the pressure containing device is loaded or stressed. With a flat surface, some of the force becomes a combination of tensile and bending stress. With rounded shapes, the forces are mostly either tensile or compressive, therefore the stress level is lower, and hence the part fails at a higher pressure.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A connecting tee comprising:
a run defining first and second openings at first and second ends thereof;
a rise defining an rise opening; and
an inner surface defining a flow path through the rise and run, the flow path being interrupted by at least one raised portion on the inner surface.

2. The connecting tee of claim 1, further comprising first and second grooves defined in an outer surface of the connecting tee and configured to receive a coupling for connecting the first and second ends of the run to pipe components.

3. The connecting tee of claim 2, wherein the at least one raised portion on the inner surface is adjacent one of the grooves at the first and second ends of the rise.

4. The connecting tee of claim 2, further comprising a third groove defined in an outer surface of the tee, the groove being configured to receive a coupling for connecting the rise end to a pipe component.

5. The connecting tee of claim 4, the at least one raised portion comprising first and second raised portions on the inner surface aligned with the first and second grooves respectively and a third raised portion on the inner surface aligned with the third groove at the rise opening.

6. The connecting tee of claim 2 wherein the outer surface at a transition from the rise to the run is arcuate around the entire periphery of the transition.

7. A connecting tee comprising:
a run defining first and second openings at first and second ends thereof configured to connect to pipe components; and
a rise defining a third opening at a rise end thereof configured to connect to a pipe component, wherein an outer surface of the connecting tee at a transition from the rise to the run is arcuate around the entire periphery of the transition, and wherein the first and second openings at the first and second ends of the run and the third opening at the rise end are configured to connect to pipe components of the same size.

8. The connecting tee of claim 7 wherein the outer surface of the connecting tee has first and second connecting grooves defined therein on the outer surface of the run and a third connecting groove on the outer surface of the rise.

9. The connecting tee of claim 7, an inner surface of the tee defining a flow path, wherein the inner surface has a plurality of raised portions defined thereon extending radially inwardly into the flow path.

10. The connecting tee of claim 8, wherein each of the plurality of raised portions is aligned with a connecting groove defined in the outer surface of the connecting tee.

11. The connecting tee of claim 10, wherein each raised portion spans the length of the groove with which it is aligned.

12. A connecting tee comprising:
a run defining first and second openings at first and second ends thereof;
a rise extending from the run and defining a rise opening at an end thereof, the connecting tee having an outer surface, wherein the outer surface is arcuate at a transition between the rise and the run around the entire periphery of the transition;
first and second connecting grooves defined in the outer surface on the run and a third connecting groove in the outer surface on the rise; and
a plurality of radially inwardly extending raised portions defined on an inner surface of the connecting tee.

13. The connecting tee of claim 12, each raised portion being in aligned with one of the connecting grooves.

14. The connecting tee of claim 13, each of the first, second and third connecting grooves having a length, wherein the length of each is groove spanned by a raised portion on the inner surface of the connecting tee.

15. The connecting tee of claim 13, wherein the first and second connecting grooves are configured to connect the first and second ends to first and second pipe components, and wherein the third groove is configured to connect the rise to a third pipe component, the first, second and third pipe components being the same size.
